(19) United States
(12) Patent Application Publication
(10) Pub. No.: US 2013/0283148 A1
(43) Pub. Date: Oct. 24, 2013

(54) Extraction of Content from a Web Page

(71) Applicants: Suk Hwan Lim, Mountain View, CA (US); Jian-Ming Jin, Beijing (CN); Li-Wei Zheng, Beijing (CN); Jian Fan, San Jose, CA (US); Eamonn O'Brien-Strain, San Francisco, CA (US); Parag Joshi, Los Gatos, CA (US)

(72) Inventors: Suk Hwan Lim, Mountain View, CA (US); Jian-Ming Jin, Beijing (CN); Li-Wei Zheng, Beijing (CN); Jian Fan, San Jose, CA (US); Eamonn O'Brien-Strain, San Francisco, CA (US); Parag Joshi, Los Gatos, CA (US)

(21) Appl. No.: 13/817,656

(22) PCT Filed: Oct. 26, 2010
(86) PCT No.: PCT/CN2010/001698

§ 371 Date: Feb. 19, 2013

(51) Int. Cl. G06F 17/22

(52) U.S. Cl. CPC G06F 17/2247
USPC 715/234

(57) ABSTRACT

A system and method are provided for extracting main content from a web page. Web page segmentation is performed on a web page to provide affinity-grouped segments. Descriptive features of at least one of the affinity-grouped segments are computed. At least one of the affinity-grouped segments is classified as a main body segment based on the computed descriptive features. Additional affinity-grouped segments are classified as to a document function based on the computed descriptive features. Classified affinity-grouped segments are assembled according to their classified document functions to provide the main content.

### BACKGROUND

Web pages make information widely available to consumers. The web pages have become increasingly more complex to manipulate with the inclusion of content such as multimedia content, embedded advertising, and online services (including links thereto). For example, a web page may display the main content (such as an article) intermingled with other auxiliary content, including background imagery, advertisements, or navigation menus, and links to additional content. A system and a method for extracting main content from a web page would be beneficial. For example, the system and method could be beneficial to a consumer or business that wishes to access the main content of a web page, for example but not limited to, for printing.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative system that can be used for extracting content from web pages according to one example of principles described herein.

FIG. 2 is a block diagram of an illustrative functionality implemented by an illustrative computerized web content extraction device, according to one example of principles described herein.

FIG. 3 is a diagram of an illustrative internet browser rendering a web page from which main content can be extracted, according to one example of principles described herein.

FIG. 4 is a diagram of an illustrative division of the web page of FIG. 3 into segments, according to one example of principles described herein.

FIG. 5 is a diagram of an illustrative segmentation of the web page of FIG. 3 into affinity-grouped segments, according to one example of principles described herein.

FIG. 6 is an illustration of a document assembled from the main content extracted from the web page illustrated in FIG. 3, according to one example of principles described herein.

FIG. 7 is a flowchart diagram of an illustrative method of extracting main content from a web page, according to one example of principles described herein.

FIG. 8 is a flowchart diagram of an illustrative method of extracting main content from a web page, according to one example of principles described herein.

Throughout the drawings, identical reference numbers designate similar, but not necessarily identical, elements.

### DETAILED DESCRIPTION

The present specification discloses various methods, systems, and devices that can be used for extracting content from web pages. A system and a method are provided for extracting the main content of a web page. Non-limiting examples of main content includes the title, main body, headings, and images. For example, the main content can be the essence of news articles from news web pages. When web browsing, some content from a web page may not be informative or of interest. For example, there can be side bars, footers, headers, advertisements, and auxiliary information for further browsing that may not be of interest. The systems and methods disclosed herein can be used to access the main content of a web page, for example but not limited to, for printing the main content.

A user may wish to utilize or adapt only the main content of a web page. For instance, a user may desire to print a physical copy of the main content of an internet article without reproducing other content of the web page, such as advertisements, or links to other pages. Similarly, a user may wish to adapt the main content of a web page into another document, such as a marketing brochure, without including content in the web page that is irrelevant to the new document. Such uses of the main content of a web page may require tedious effort on the part of a user to distinguish among the different types of content on the web page and retrieve only the desired content (the main content).

In one example, the web content extraction process described herein extracts main content from web pages based on an affinity-based web page segmentation. From the segments collected from the web page segmentation, descriptive features for each of the segments are computed. Based on the computed descriptive features, main content of the web page, such as but not limited to, the main body, title, headers, and images, are determined.

In an example, a system and method described herein is applicable to web pages having content with irregular shape, for example, due to content such as advertisements and other supplemental links that are intermingles and interspersed within the main content of the web page. In another example, a system and method described herein is applicable to web pages having more than one article within the page. In another example, a system and method described herein is applicable to web pages having paragraph separation within the main body which is beneficial for, for example, web printing. A system and method herein also can use line-breaking features of a web page for segmenting text segments of a web page in an example. A system and method herein does not depend on the content of the web page being mainly text, and can be applied to web pages that include more multimedia contents to extract main content, such as but not limited to, articles. A system and method herein determines the main content of web pages using descriptive features computed based on the segments and is extendable for use with more general types of web documents.

The methods, systems, and devices disclosed in the present specification accomplish this goal by applying an affinity-based page segmentation algorithm to segment a web page into affinity-grouped segments, computing descriptive features of at least one of the affinity-grouped segments, classifying a first affinity-grouped segment having the highest main body classifier values as a main body, where the main body classifier value is determined by computing a main body classifier function based on the descriptive features of the first affinity-grouped segment, and assembling the classified affinity-grouped segments according to the classified functions to provide the extracted main content. The methods, systems, and devices can further comprise classifying a second affinity-grouped segment as to a function in a document using a function classifier that is computed based on the descriptive feature of a vertical location of the second affinity-grouped segment, in an example, the extracted main content can be an article, such as but not limited to a news article.

As used in the present specification and in the appended claims, the term “web page” refers to a document that can be retrieved from a server over a network connection and viewed in a web browser application.

As used in the present specification and in the appended claims, the term “node” refers to one of a plurality of coherent units into which the entire content of a web page has been partitioned.

As used in the present specification and in the appended claims, the term “collectively exhaustive,” as applied to a node, refers to the property wherein all such nodes for a particular web page comprise in their sum the totality of content displayed on that web page.

As used in the present specification and in the appended claims, the term “coherent,” as applied to a node, refers to the characteristic of having content only of the same type or property.

A “computing device” or “computer” is any machine, device, or apparatus that processes data according to computer-readable instructions that are stored on a computer-readable medium either temporarily or permanently. A computing device” or “computer” can be an ensemble of more than one machine, device, or apparatus networked together. A “software application” (also referred to as software, an application, computer software, a computer application, a program, and a computer program) is a set of instructions that a computer can interpret and execute to perform one or more specific tasks. A “date file” is a block of information that durably stores data for use by a software application.

The term “computer-readable medium” refers to any medium capable storing information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily ail referring to the same embodiment.

The principles disclosed herein will now be discussed with respect to illustrative systems, devices, and methods for extracting main content from a web page.

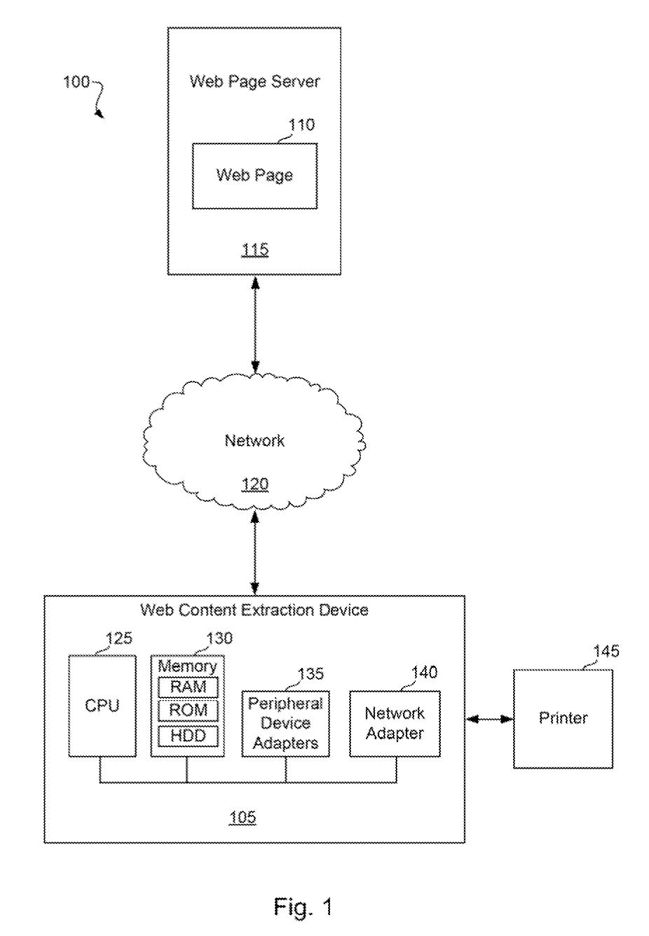

Referring now to FIG. 1, an illustrative system (100) for extracting the main content of a web page includes a web content extraction device (105) that has access to a web page (110) stored by a web page server (115). In the present example, for the purposes of simplicity in illustration, the web content extraction device (105) and the web page server (115) are separate computing devices communicatively coupled to each other through a mutual connection to a network (120). However, the principles set forth in the herein extend equally to any alternative configuration in which a web content extraction device (105) has complete access to a web page (110). As such, alternative examples within the scope of the principles of the present specification include, but are not limited to, examples in which the web content extraction device (105) and the web page server (115) are implemented by the same computing device, examples in which the functionality of the web content extraction device (105) is implemented by a multiple interconnected computers (e.g., a server in a data center and a user's client machine), examples in which the web content extraction device (105) and the web page server (115) communicate directly through a bus without intermediary network devices, and examples in which the web content extraction device (105) has a stored local copy of the web page (110) from which main content is to be extracted.

The web content extraction device (105) of the present example is a computing device configured to retrieve the web page (110) hosted by the web page server (115) and divide the web page (110) into multiple coherent, functional blocks. In the present example, this is accomplished by the web content extraction device (105) requesting the web page (110) from the web page server (115) over the network (120) using the appropriate network protocol (e.g., Internet Protocol (“IP”)). Illustrative processes of extracting main content from a web page will be set forth in more detail below.

To achieve its desired functionality, the web content extraction device (105) includes various hardware components. Among these hardware components may be at least one processing unit (125), at least one memory unit (130), peripheral device adapters (135), and a network adapter (140). These hardware components may be interconnected through the use of one or more busses and/or network connections.

The processing unit (125) may include the hardware architecture necessary to retrieve executable code torn the memory unit (130) and execute the executable code. The executable code may, when executed by the processing unit (125), cause the processing unit (125) to implement at least the functionality of retrieving the web page (110), determining the affinity-grouped segments of the web page (110), classifying affinity-grouped segments according to document function, and assembling the classified affinity-grouped segments according to the classified functions to provide an extracted article, according to the methods described below. In the course of executing code, the processing unit (125) may receive input from and provide output to one or more of the remaining hardware units.

The memory unit (130) may be configured to digitally store data consumed and produced by the processing unit (125). The memory unit (130) may include various types of memory modules. Including volatile and nonvolatile memory. For example, the memory unit (130) of the present example includes Random Access Memory (RAM), Read Only Memory (ROM), and Hard Disk Drive (HDD) memory. Many other types of memory are available in the art, and the present specification contemplates the use of any type(s) of memory (130) in the memory unit (130) as may suit a particular application of the principles described herein, in certain examples, different types of memory in the memory unit (130) may be used for different data storage needs. For example, in certain examples the processing unit (125) may boot from ROM, maintain nonvolatile storage in the HDD memory, and execute program code stored in RAM.

The hardware adapters (135,140) in the web content extraction device (105) are configured to enable the processing unit (125) to interface with various other hardware elements, external and internal to the web content extraction device (105). For example, peripheral device adapters (135) may provide an interface to input/output devices to create a user interface and/or access external sources of memory storage. Peripheral device adapters (135) may also create an interface between the processing unit (125) and a printer (145) or other media output device. For example, in examples where the web content extraction device (105) is configured to generate a document based on main content extracted from the web page, the web content extraction device (105) may be further configured to instruct the printer (145) to create one or more physical copies of the document.

A network adapter (140) may provide an interface to the network (120), thereby enabling the transmission of data to and receipt of data from other devices on the network (120), including the web page server (115).

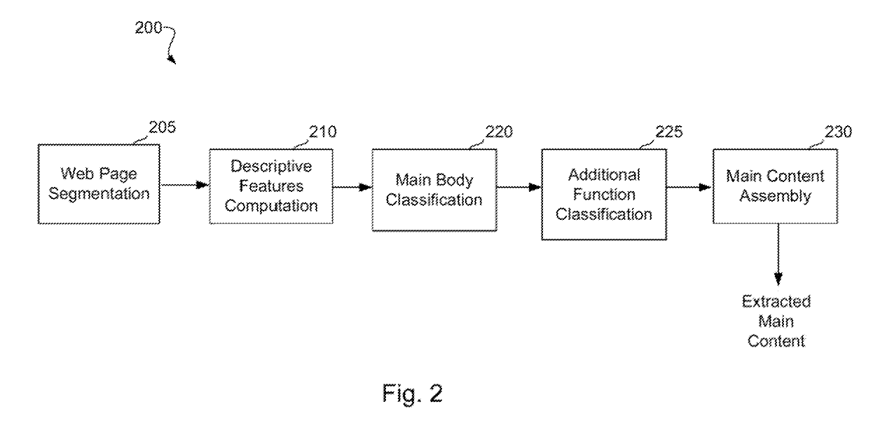

Referring now to FIG. 2, a block diagram is shown of an illustrative functionality (200) implemented by a web content extraction device (105, FIG. 1) for extraction of main content from a web page consistent with the principles described herein. Each module in the diagram represents an element of functionality performed by the processing unit (125) of the web content extraction device (105, FIG. 1). Arrows between the modules represent the communication and interoperability among the modules.

The operations in block 205 of FIG. 2 are performed on a web page. The web page can be obtained using a URL received by a web page receiving module. For example, the web page receiving module may perform the functions of fetching the web page from its server and rendering the web page to determine a layout of the content in the web page. The URL may be specified by a user of the web content extraction device (105, FIG. 1) or, alternatively, be determined automatically. A web page receiving module may then request the web page from its server over a network such as the internet using the URL. The web page received in response to the request is then made available to a web segmentation module, which partitions the web page content into affinity-grouped segments, as described below.

In block 205 of FIG. 2, web page segmentation is performed on a web page to provide affinity-grouped segments. The web page segmentation can be performed by a web segmentation module. In an example, the web page segmentation is performed according to an example described in international application no. PCT/CN2010/000523, filed Apr. 19, 2010, titled “Segmenting A Web Page Into Coherent Functional Blocks.” The web page segmentation can be performed by segmenting (parsing) the web page into a plurality of coherent and collectively exhaustive nodes (multiple basic content nodes or “atoms”), computing at least one matrix of affinity values between the separate nodes to form at least one affinity matrix, and clustering the nodes into functional areas or blocks based on the at least one matrix of affinity values. The “atoms” are nodes that should never have to be broken up into smaller pieces. The functional blocks are the affinity-grouped segments. Many methods of decomposing web page content into nodes having the above properties are available or pending development. Any suitable method of decomposing web page content into such nodes is commensurate with the scope of the present specification. For example, one such method of decomposing a web page into nodes having the above properties is using a hierarchical tree structure in a Document Object Model (DOM) of the web page.

The “affinity” is a measure of the probability that the two nodes are interdependent or related to the same subject matter. The affinity value between two different nodes can be computed as, but is not limited to, a Euclidean or block distance between the two nodes in the rendered web page; a distance between the two nodes in the DOM tree; the respective hierarchical levels of the two nodes in the DOM tree; a degree of horizontal alignment between the two nodes in the rendered web page; a degree of vertical alignment between the two nodes in the rendered web page; a number of other nodes displayed between the two nodes in the rendered web page; a difference in type between the two nodes (e.g., image, text (HTML heading1, heading2, paragraph), embedded content); a degree of difference in font size of text present in the two nodes; a difference in the number of characters in text present in the two nodes; a degree of difference in visual appearance (e.g., using one or more histograms of color, intensify, edge orientation, or magnitude); a difference in node size; and a degree of overlap or enclosure between the two nodes. In an example, the affinity value can be computed according to an example described in international application no, PCT/CN2010/074813, filed Jun. 30, 2010, titled “Determining Similarity Between Elements Of An Electronic Document.” If the measured affinity between two nodes is higher than a predetermined or adaptively computed threshold, the two nodes are “connected.” The computed affinity values can be assembled into a matrix for further computation. An affinity matrix computation module can be used to calculate one or more matrices in which a numeric representation of the affinity between any two nodes of the web page is given. The affinity matrix computation module can be separate from or a part of the web segmentation module. Groups of interconnected nodes are then clustered together to create functional blocks (affinity-grouped segments), thereby achieving the segmentation of the web page. One method of doing so is to derive a connectivity map between the nodes based on one or more predetermined or adaptively computed thresholds. In other words, if the measured affinity between two nodes is higher than a predetermined or adaptively computed threshold, the two nodes are considered “connected.” The clustering can be performed using a separate module.

A heuristics rule-based approach or machine learning based approach can be applied when combining the affinity matrices and using them for clustering nodes or atoms. Both of these approaches can be applicable, as a non-limiting example, for extracting a news article from a web page. A rule-based solution can be used for identifying, e.g., the main body (an example affinity-grouped segment). Many different types of rules with different affinities, using various information, such as but not limited to block positions, tags, font families and DOM structure, can be applied. Following is an example rule for computing affinities, performed as a two-stage process. However, many other types of affinities and rules can be used. The first stage is applying a clustering determination threshold to the nodes, that is, a pair of nodes is clustered if the following clustering determination threshold is satisfied:

(HTML tags are the same) && (Font sizes are the same) && (Font styles are the same) && (Font colors are the same) && (At least one side is aligned) && (There is horizontal overlap of at least 70%)
The first stage is targeted toward ensuring that the nodes for the main body are clustered. Many of the main body segments are clustered in this initial approximate clustering. In the second stage, after the first-stage clustering, it is determined whether to further cluster pairs of nodes based on block geometric properties (such as but not limited to distance, size, overlap, alignment, intersection, enclosure), font properties (such as but not limited to font family, size, color and type) and/or DOM tree structure (such as but not limited to POM node distance). The affinities also can be determined based on image similarities. An example rule for merging nodes in the second, refining stage is as follows:
if (tagDistance>0.5)
   result=result+30;
if (fontSizeDistance>0)
   result=result+30;
if ((fontColorAffinity>0) && (nodeNumAffinity>3))
   result=result+30;
if (horizontalOverlapAffinity<0.5)
   result=result+30;
if (intersectAfftnity==0)
   result=result+blockDistance/_totWidth*100;
if (enclosureAffinity>0)
   result=result+30+30*blockSizeAffinity;
if (domDistAffinity>4)
   result=result+30;
result=result+3*nodeNumAffinity;
   If (horizontalOverlapAffinity<0.5) refers to if the maximum value of horizontal overlap is smaller than 50%. If(intersectAffinity==0) refers to if it doesn't intersect, otherwise don't add. If(enclosureAffinity>0) refers to if there is no enclosure. After this second, refining stage, the result value can be compared to predetermined or adaptively determined threshold to determine if the nodes should be clustered. In this example, images are not clustered with text or other images.

In block 210 of FIG. 2, descriptive features of at least one of the affinity-grouped segment identified in block 205 are computed. A descriptive features computation module can be used to perform the processes described in connection with block 210. Once the web page is divided into affinity-grouped segments, properties of each segment are computed to determine if they belong to certain functions of a document. That is, for each affinity-grouped segment, descriptive features are computed, where the descriptive features relate to the likelihood of the affinity-grouped segment having a document function. As pointed out above, non-limiting examples of document functions include main body, title, headers, and representative images. Non-limiting examples of descriptive features are the total number of nodes/atoms without a segment (N), the total area of a segment (A); the total number of characters within a segment (C); the biggest font size within a segment (F); the vertical location of the segment in the web page (V); and the horizontal location of the segment in the web page (H).

From the descriptive features computed for an affinity-grouped segment, a weighted computation of the descriptive features can be performed to determine a document function of the affinity-grouped segment. The weighted computation of the descriptive features for determining a document function based on the descriptive features (a classifier) may be determined by heuristics or via a learning framework (such as but not limited to a support vector machine (SVM) or other machine learning tool). The learning framework can be trained to identify a document function based on the computed descriptive features using training examples that include web page segmentation results and the manual labeling of the segments of the training examples. In an example of training a learning framework, for a given training web page with a number of affinity-grouped segments, the affinity-grouped segments that are main body, title and relevant images are labeled, and then the descriptive features are computed. A vector including values for the descriptive features and the ground truth labels are input into a learning framework to generate a classifier.

Affinity-grouped segment classification is performed in blocks 220 and 225 of FIG. 2. At least one segment classification module can be used to perform the classification described in connection with blocks 220 and/or 225. In block 220 of FIG. 2, at least one affinity-grouped segment is classified as a main body segment based on the computed descriptive features. As described above, the main body classifier can be determined by heuristics or via a learning framework. The main body classifier is used to identify the affinity-grouped segments that have the document function of the main body, in an example, the main body classifier computes a main body classifier value, a weighted sum of descriptive features of the total number of nodes/atoms without a segment (N), the total area of a segment (A), and the total number of characters within a segment (C), for each of the candidate affinity-grouped segments. The general idea is for the main body classifier to select large affinity-grouped segments that contain a long sequence of characters as the main body. In an example, the candidate affinity-grouped segments having the highest main body classifier value(s) are classified as the main body. In another example, main body classifier value(s) above a predetermined threshold, or an adaptively determined threshold, are classified as the main body.

In block 225, additional affinity-grouped segments are classified as to a document function based on the computed descriptive features. A title classifier, a header classifier, and a representative image classifier can be determined by heuristics or via a learning framework as described above, and used to classify additional affinity-grouped segments as having document functions of title, header, and/or representative image, respectively, based on the computed descriptive features.

In an example, a title classifier computes the descriptive features of a weighted sum of biggest font size within a segment (F) and vertical location of the segment in the web page (V), and classifies affinity-grouped segment(s) with the biggest font size and a vertical location closest to the top of the page (i.e., that are near the top of the web page) as having the document function of title.

In an example, a representative image classifier computes the descriptive features of a weighted sum of the total area of a segment (A) and vertical location of the segment in the web page (V), and classifies affinity-grouped segments) within or near the bounds of the main body that are the largest in size as representative images. In an example, if a “most representative” image is desired, the “most representative” image can be determined as the image segment that has maximum value of the weighted sum of A and V. In another example, if k representative images are desired, the k image segments that have the highest representative image classifier values (computed from the weighted sum of A and V) are selected. In an alternative example, if k representative images are desired, one may determine the k using a representative image classifier generated by computing statistics (e.g., standard deviations) of the weighted sum of A and V and determining the number of images that should be added. In another example, a representative image classifier can be generated using outlier rejection methods. In an example, an affinity-grouped segment can be determined as the caption of an image by determining the text that is closest (both geometrically and in the DOM tree) to the image. In this example, the image caption can be selected as the affinity-grouped segment having text that is semantically relevant to the main body of text.

In an example, the affinity-grouped segment(s) can be classified as the main body first, and the additional affinity-grouped segments) can be classified as a file and/or most representative image based classifiers computed based on descriptive features including relative vertical locations (Vᵣ) that are measures of the position of a segment relative to the main body.

In block 230, the classified affinity-grouped segments are assembled according to their classified document functions to provide the main content. An assembly module can be used to perform the assembly described in connection with block 230. The classified affinity-grouped segments can be assembled to construct the main content by properly ordering the nodes in each affinity-grouped segment. The assembled main content can be, but is not limited to a, printable version of an extracted document or news article. In the ordering, the order traversal in the DOM tree and also the vertical locations can be taken into account. In an example implementation, the extracted main content (such as but not limited to a resulting document) can be output in an intermediate XML format. A separate layout or rendering can take an output XML format and layout a document and perform additional manipulation, such as but not limited to, generate a PDF file.

In an example, the web page includes main content that spans multiple pages father than a single page. When main content spans multiple pages, a crawler can be run that fetches a sequence of pages and blocks 205, 210, 220, and 225 can be performed for each page. The affinity-grouped segment classified as the title for the first page is retained, while any affinity-grouped segment classified as a title on subsequent pages are discarded. In performing the assembly in block 230, affinity-grouped segments classified as main body segments on each page are connected. For example, the end of the (i)th main body of the Ah page is connected to the beginning of the (i+1)th main body of the (i+1)th page. The locations of the representative images are computed such that the relative position between the text blocks and the image blocks are maintained.

In an example, the web content extraction device (105, FIG. 1) may be further configured to assemble the main content incorporating only some of the classified affinity-grouped segments. In this way, content may be extracted from the web page and repurposed into a different web page or other type of media, such as a printed document. In certain examples, the web content extraction device (105, FIG. 1) may be configured to determine which of the classified affinity-grouped segments are most relevant to main content to provide the document being created. This determination may be made, for example, using the type of document function that the classified affinity-grouped segments are classified as having. For example, the main content may be assembled to place the title at the top, a “most representative” image below the title, and the main body below the “most representative” image. In another example, the main content may be assembled to place the title at the top and below the title, a number k representative images can be interspersed with the main body.

This process of web content extraction may be performed automatically in response to an automatic or user-generated trigger. Thus, in certain examples a user may instruct a computer to print a web page containing the main content (an article of interest in a web page) by pressing a “print” button. The computer may perform the web content extraction as described above, then automatically generate a document incorporating only the extracted main content, and print the document.

In other examples, the web content extraction device (105, FIG. 1) or another device may be configured to use the extracted main content from a web page according to the above methods. For example, the web content extraction device (105, FIG. 1) may be a mobile device with an internet browser that extracts main content from retrieved web pages and provide it as an optimal layout for the screen size of the mobile device. By extracting the main content from the web page and assembling the main content in a reformatted layout such that the main content remains visually intact, the mobile device can preserve the integrity of main content from a web page without necessarily preserving the original formatting of the web page.

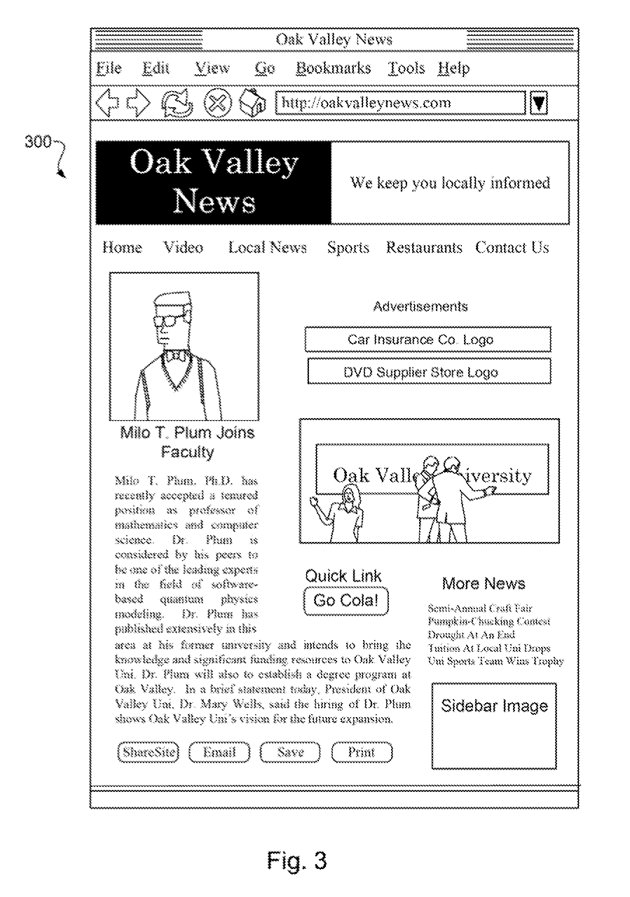

FIGS. 3-6 provide illustrations of various aspects of the process of extracting main content from a web page as outlined above.

FIG. 3 is a diagram of an illustrative web browser (300) displaying a web page from which main content can be extracted consistent with the principles described above.

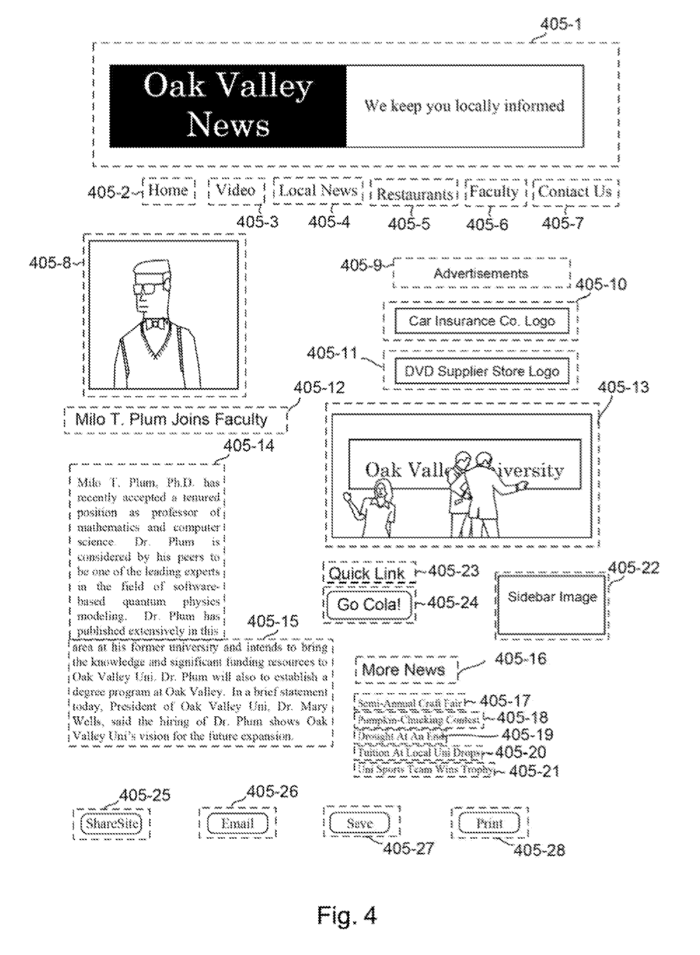

FIG. 4 is a diagram of the decomposition of the illustrative web page of FIG. 3 into a plurality of coherent nodes (405-1 to 405-37) consistent with the functionality (200) described with reference to FIG. 2. As shown in FIG. 4, these nodes (405-1 to 405-28) conform to the requirements of being atomic and coherent. Additionally, the nodes (405-1 to 405-28) are collectively exhaustive and mutually exclusive, as all of the visible content from the web page of FIG. 3 is present in the sum of the nodes (405-1 to 405-28) and no two nodes (405-1 to 405-28) share the same content.

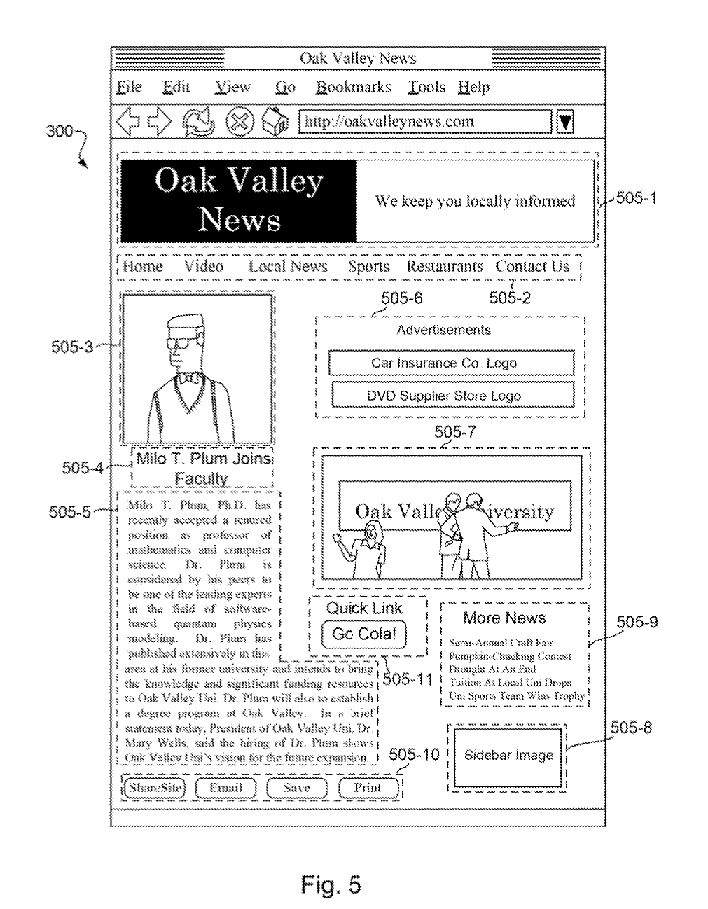

FIG. 5 is a diagram of the web page illustrated in FIG. 3 as decomposed into affinity-grouped segments (505-1 to 505-11) by clustering together groups of nodes (405-1 to 405-25) where each node in an affinity-grouped segment (505-1 to 505-11) has an affinity value for each other node in that affinity-grouped segment (505-1 to 505-11) that is greater than a predetermined or adaptively computed threshold. In a subsequent process, at least one of the affinity-grouped segments (505-1 to 505-11) is classified as to document function based on the result of applying a function classifier to descriptive features computed for the affinity-grouped segments, as described above. For example, affinity-grouped segment (505-3) can be classified as a “most representative” image based on the result of applying an image classifier function to the affinity-grouped segments. As another example, affinity-grouped segment (505-4) can be classified as title based on the result of applying a title classifier function to the affinity-grouped segments. As yet another example, affinity-grouped segment (505-5) can be classified as a main body based on the result of applying a main body classifier function to the affinity-grouped segments. Other affinity-grouped segments can be classified according to a document function as described above.

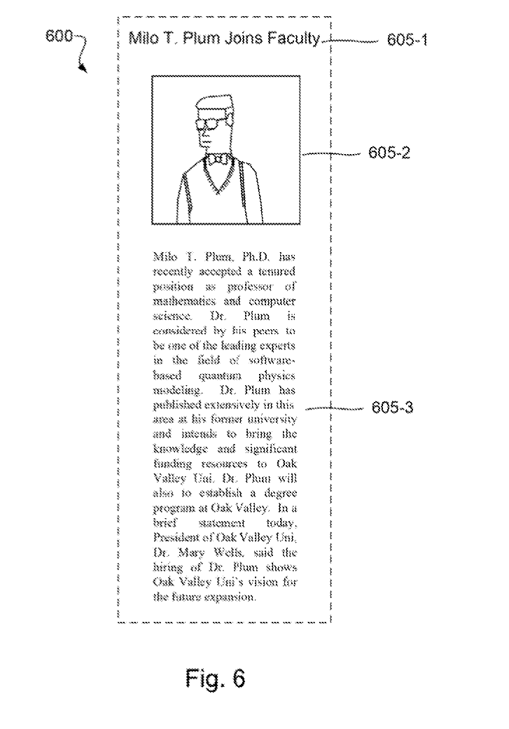

FIG. 6 is an illustration of a document (800) assembled from the main content extracted from the web page illustrated in FIG. 3. The main content is assembled: to place the affinity-grouped segment classified as the title (605-1) on top, the affinity-grouped segment classified as the “most representative” image (605-2) below the title (605-1), and the affinity-grouped segments classified as the main body (805-3) below the “most representative” image (605-2). If the web page of an example includes main content that spans multiple pages rattier than a single page, the affinity-grouped segment classified as the title for the first page is retained, while any affinity-grouped segments classified as a title on any subsequent pages are discarded, affinity-grouped segments classified as main body on each of the multiple pages are connected to form a single main body in the extracted main content, and the locations of the representative images are computed such that the relative position between the text blocks and the image blocks are maintained, as described above.

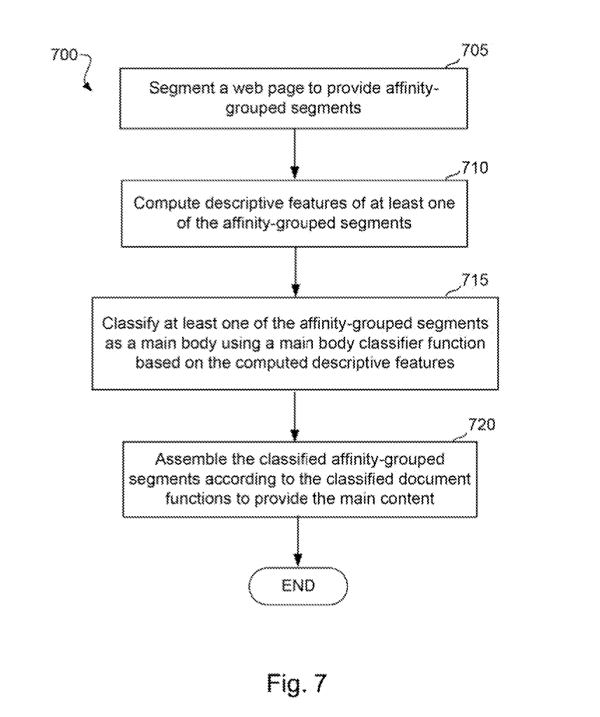

Referring now to FIG. 7, a flowchart is shown of a method (700) summarizing an example procedure for extracting the main content from a web page. This method (700) may be performed by, for example, the processing unit (125, FIG. 1) of a computerized web content extraction device (105, FIG. 1). The method (700) includes segmenting (705) the web page into a plurality of affinity-grouped segments. Descriptive features of at least one of the affinity-grouped segment are computed (710). At least one of the affinity-grouped segments is classified (715) as a main body segment based on the computed descriptive features. The classified affinity-grouped segments are assembled (720) according to their classified document functions to provide the main content. The main content can be an article, such as but not limited to a news article.

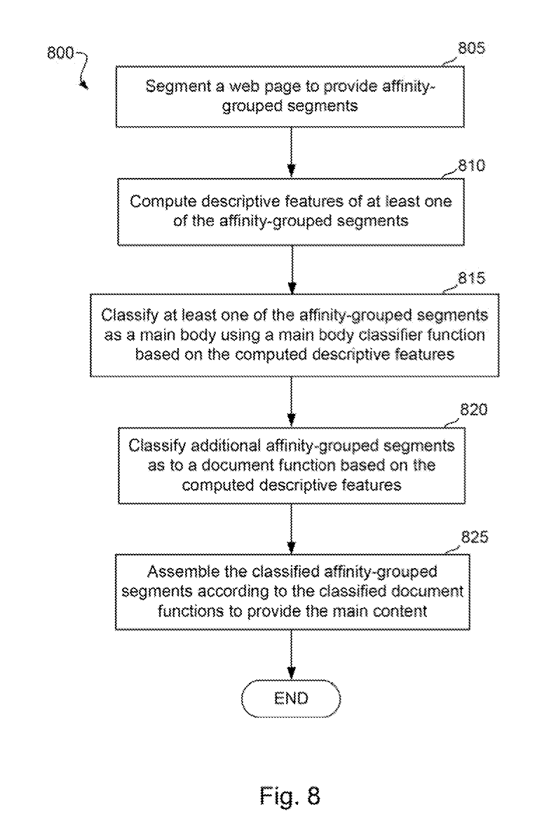

Referring now to FIG. 8, a flowchart is shown of a method (800) summarizing another example procedure for extracting the main content from a web page. This method (800) may be performed by, for example, the processing unit (125, FIG. 1) of a computerized web content extraction device (105, FIG. 1). The method (800) includes segmenting (805) the web page info a plurality of affinity-grouped segments. Descriptive features of at least one of the affinity-grouped segment are computed (810). At least one of the affinity-grouped segments is classified (815) as a main body segment based on the computed descriptive features. At least one additional affinity-grouped segment is classified (720) as to a document function based on the computed descriptive features. The classified affinity-grouped segments are assembled (825) according to their classified document functions to provide the main content. The main content can be an article, such as but not limited to a news article.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method performed by a physical computing system comprising at least one processor for extracting main content from a web page, said method comprising:
applying an affinity-based page segmentation algorithm to segment the web page into affinity-grouped segments;
computing descriptive features of at least one affinity-grouped segment;
classifying a first affinity-grouped segment having highest main body classifier values as a main body, wherein the main body classifier value is determined by computing a main body classifier function based on the descriptive features of the first affinity-grouped segment; and
assembling the classified affinity-grouped segments according to the classified functions to provide the extracted main content.

2. The method of claim 1, further comprising classifying a second affinity-grouped segment as to a function in a document using a function classifier that is computed based on the descriptive feature of a vertical location of the second affinity-grouped segment.

3. The method of claim 2, wherein the descriptive features are selected from a group consisting of a total number of nodes without an affinity-grouped segment, a total area of an affinity-grouped segment, a total number of characters within an affinity-grouped segment, a font size within an affinity-grouped segment, a vertical location of an affinity-grouped segment, and a horizontal location of an affinity-grouped segment.

4. The method of claim 2, further comprising ordering the nodes of the classified affinity-grouped segments to provide an ordered document object model tree, and outputting the extracted article based on the document object model tree.

5. The method of claim 2, wherein the main body classifier function computes the main body classifier value for the first affinity-grouped segment based on a weighted sum of the descriptive features of a total number of nodes without an affinity-grouped segment, a total area of the affinity-grouped segment, and a total number of characters within the affinity-grouped segment, and wherein a large affinity-grouped segment that contains a long sequence of characters is determined as a main body.

6. The method of claim 2, wherein the function classifier classifies the second affinity-grouped segment as a title based on a weighted sum of the vertical location of the second affinity-grouped segment measured relative to the main body segment and the descriptive feature of a font size within the second affinity-grouped segment, and wherein the second affinity-grouped segment is determined as a title if the second affinity-grouped segment comprises characters having the biggest font size and having the vertical location closest to the top of the web page.

7. The method of claim 2, wherein the function classifier classifies the second affinity-grouped segment as a representative image based on a weighted sum of the vertical location of the second affinity-grouped segment measured relative to the main body segment and the descriptive feature of a total area of the second affinity-grouped segment, and wherein the second affinity-grouped segment is determined as a representative image if the second affinity-grouped segment lies within or near the bounds of the main body segment and is the largest in size.

8. The method of claim 7, further comprising classifying as a most representative image the second affinity-grouped segment having the maximum value of the weighted sum of the vertical location of the second affinity-grouped segment measured relative to the main body segment and the total area of the second affinity-grouped segment.

9. The method of claim 2, wherein applying the affinity-based page segmentation algorithm to segment the web page into affinity-grouped segments comprises:
parsing content from the web page into a plurality of coherent, collectively exhaustive nodes;
calculating at least one matrix of affinity values between each of the nodes with the physical computing system; and
clustering the nodes into affinity-grouped segments based on the affinity values in the at least one matrix.

10. The method of claim 2, wherein the web page spans multiple document pages, the method further comprising:
classifying a second affinity-grouped segment on the first document page of the web page as a title using a function classifier that is computed based on a weighted sum of the descriptive feature of the vertical location of the second affinity-grouped segment measured relative to the main body segment and the descriptive feature of a font size within the second affinity-grouped segment, wherein the second affinity-grouped segment is determined as the title if the second affinity-grouped segment comprises characters having the biggest font size and having the vertical location closest to the top of the first document page; and
assembling the classified affinity-grouped segments according to the classified functions to provide an extracted article, wherein the assembling comprises discarding second affinity-grouped segments classified as titles on subsequent document pages of the web page and connecting the second affinity-grouped segments classified as main bodies according to the ordering of the multiple pages of the web page.

11. The method of claim 2, wherein applying the affinity-based page segmentation algorithm to segment the web page info affinity-grouped segments comprises;
parsing content from the web page into a plurality of coherent: collectively exhaustive nodes;
calculating at least one matrix of affinity values between each of the nodes with the physical computing system; and
clustering the nodes into affinity-grouped segments based on the affinity values in the at least one matrix.

12. The method of claim 11, wherein clustering the nodes info affinity-grouped segments based on the affinity values in the at least one matrix comprises:
performing a first clustering of a pair of nodes if the pair of nodes satisfy a clustering determination threshold; and
clustering the results from the first clustering based on applying a merging rule to at feast one of a block geometric property, a font property, or a document object model tree structure of the results from the first clustering.

13. A method performed by a physical computing system comprising at least one processor for extracting an article from a web page, said method comprising:
applying an affinity-based page segmentation algorithm to segment a web page info affinity-grouped segments;
computing descriptive features of at least one affinity-grouped segment;
classifying a first affinity-grouped segment having highest main body classifier values as a main body, wherein the main body classifier value is determined by computing a main body classifier function based on the descriptive features of the first affinity-grouped segment; and
assembling the classified affinity-grouped segments according to the classified functions to provide the extracted article.

14. The method of claim 13, further comprising classifying a second affinity-grouped segment as to a function in a document using a function classifier that is computed based on the descriptive feature of a vertical location of the second affinity-grouped segment.

15. The method of claim 14, wherein applying the affinity-based page segmentation algorithm to segment the web page into affinity-grouped segments comprises:
parsing content from the web page into a plurality of coherent, collectively exhaustive nodes;
calculating at least one matrix of affinity values between each of the nodes with the physical computing system; and
clustering the nodes into affinity-grouped segments based on the affinity values in the at least one matrix.

16. The method of claim 15, wherein clustering the nodes into affinity-grouped segments based on the affinity values in the at least one matrix comprises:
performing a first clustering of a pair of nodes if the pair of nodes satisfy a clustering determination threshold; and
clustering the results from the first clustering based on applying a merging rule to at least one of a block geometric property, a font property, or a document object model tree structure of the results from the first clustering.

17. Apparatus for extracting main content from a web page, comprising:
a memory storing computer-readable instructions; and
a processor coupled to the memory, to execute the instructions, and based at least in part on the execution of the instructions, to perform operations comprising:
applying an affinity-based page segmentation algorithm to segment a web page into affinity-grouped segments;
computing descriptive features of at least two affinity-grouped segment;
classifying a first affinity-grouped segment having highest main body classifier values as a main body, wherein the main body classifier value is determined by computing a main body classifier function based on the descriptive features of the first affinity-grouped segment; and
assembling the classified affinity-grouped segments according to the classified functions to provide the extracted main content.

18. The apparatus of claim 17, wherein, based at least in part on the execution of the instructions, the processor performs operations further comprising classifying a second affinity-grouped segment as to a function in a document using a function classifier that is computed based on the descriptive feature of a vertical location of the second affinity-grouped segment.

19. At least one computer-readable medium storing computer-readable program code adapted to be executed by a computer to implement a method comprising;
applying an affinity-based page segmentation algorithm to segment a web page into affinity-grouped segments;
computing descriptive features of at least one affinity-grouped segment;
classifying a first affinity-grouped segment having highest main body classifier values as a main body, wherein the main body classifier value is determined by computing a main body classifier function based on the descriptive features of the first affinity-grouped segment; and
assembling the classified affinity-grouped segments according to the classified functions to provide the extracted main content.

20. The at least one computer-readable medium of claim 19, wherein the computer-readable program code is adapted to be executed by a computer to implement a method further comprising classifying a second affinity-grouped segment as to a function in a document using a function classifier that is computed based on the descriptive feature of a vertical location of the second affinity-grouped segment.
